(19) United States
(12) Patent Application Publication
(10) Pub. No.: US 2015/0021487 A1
(43) Pub. Date: Jan. 22, 2015

(54) TWO-DIMENSIONAL IMAGE DETECTING SYSTEM

(71) Applicant: SHIMADZU CORPORATION, Kyoto-shi (JP)

(72) Inventors: Satoshi SANO, Kyoto-shi (JP); Toshiyuki SATO, Kyoto-shi (JP); Koichi TANABE, Kyoto-shi (JP); Toshinori YOSHIMUTA, Kyoto-shi (JP)

(21) Appl. No.: 14/322,462

(22) Filed: Jul. 2, 2014

(30) Foreign Application Priority Data
Jul. 17, 2013 (JP) 2013-148598

(51) Int. Cl. G01T 1/20; G01N 23/04

(52) U.S. Cl. CPC G01T 1/20; G01N 23/043
USPC 250/363.01; 378/44; 250/208.1

(57) ABSTRACT

When a conventional idea of determining a setting condition from a parameter of resolution (image resolution) is changed to use an X-ray tube with a stable focus size, setting conditions are determined from a focus size φ [μm] of the X-ray tube. The minimum radiography size b [μm] is settable from the focus size φ [μm] and φ≦b/2. A magnification rate ε is settable from the set minimum radiography size b [μm], a pixel pitch d [μm] of an X-ray detector, and bε/d≧5. Consequently, the minimum radiography size b [μm] and the magnification rate ε are each settable with use of the X-ray tube having the stable focus size φ [μm]. This results in stable radiography or fluoroscopy through magnifying an object in minute size.

### TECHNICAL FIELD

The present invention relates to a two-dimensional image detecting system configured to detect a two-dimensional image based on light or radiation detected with a two-dimensional array type detector. More particularly, the present invention is directed to a technique of a two-dimensional array type detector for use in minute observation in which an object in minute size is magnified for radiography or fluoroscopy.

### BACKGROUND ART

A two-dimensional image detecting system is used for a non-destructive inspecting apparatus. Examples of an object used in the non-destructive inspecting apparatus include an electron part prior to mounting such as an integrated circuit (IC) arranged on a through hole, patterns, a solder joint, or a palette of a mounting substrate or a multi-layered substrate, a casting such as a metal, or a molded product such as a videocassette recorder.

In recent years, it is likely to fully introduce three-dimensional mounting that ICs are laminated on one another for device integration. However, a technique of non-destructive inspection has not been established. Specifically, the technique relates to a through-silicone via (TSV) having electrodes inserted into a through hole of a wafer bump or a silicon substrate as an element for three-dimensional mounting. Accordingly, a device that allows quality determination non-destructively is needed in a development site or a production site.

Non-destructive inspection of a metal such as a bump is conducted through fluoroscopy with X-rays or X-ray computerized tomography (CT). In the case of X-ray CT, two-dimensional images based on X-rays detected with a two-dimensional array type detector are reconstructed to generate a three-dimensional image. Consequently, an internal structure is observable three-dimensionally through the X-ray CT. This achieves accurate identification of a defective position. On the other hand, it takes much time to obtain a number of two-dimensional images necessary for reconstruction. Accordingly, it also takes much time to perform calculation for the reconstruction. This causes an increased total inspection time. Such a drawback may arise.

In contrast to this, although a three-dimensional shape of a detective portion is not determined through fluoroscopy with X-rays, the fluoroscopy with X-rays takes extremely less inspection time than that with the X-ray CT. Accordingly, the fluoroscopy is effective in inspecting many productions. An approach commonly used in the above two modes is magnification radiography. In the magnification radiography, an object is approached to a generating source such as an X-ray tube (source). Such a mode is described, for example, in Japanese Patent Publication No. 2007-203061 A.

### SUMMARY OF INVENTION

### Technical Problem

However, with the current state of the art, the system in the magnification radiography for identifying the defective of several micrometers possesses an unclear configuration condition (setting condition). The microbump in current circulation typically has a size of 20 μm, and it is required to detect voids (defectives) of 4 μm or more in the bump. An X-ray fluoroscopy apparatus for radiography or fluoroscopy of bumps or voids with such sizes is in progress. Moreover, setting conditions of an X-ray tube such as a focus size, a pixel size, and a magnification rate are unclear upon such minute observation. More excellent resolution is obtainable with a smaller focus size. There is a tube having a focus size of less than 1 μm, for example. On the other hand, such the tube with the minute focus size operates unstably. Accordingly, a system that allows minute observation with a certain focus size (e.g., 1 μm) is required.

The present invention has been made regarding the state of the art noted above, and its object is to provide a two-dimensional image detecting system that allows stable radiography or fluoroscopy through magnifying an object in minute size.

### Solution to Problem

To fulfill the above object, Inventors have made intensive research and attained the following findings.

Specifically, higher resolution (image resolution) is more desirable for magnifying an object in minute size for radiography or fluoroscopy. For instance, bumps or voids in minute size are observable with higher resolution. Here, actual resolution depends on performance of an X-ray source (e.g., an X-ray tube). In other words, enhanced resolution is not expectable without a minute focus size of the X-ray source. Therefore, changing an idea leads to attention to parameters other than the focus size.

As mentioned above, a smaller focus size achieves the enhanced resolution. On the other hand, a too small focus size causes unstable operation of the generating source (the X-ray tube as the radiation source for X-rays). Then, an attention is given to determination of a setting condition, such as a magnification rate, from a focus size upon using a generating source having a focus size with which no operation is unstable.

The following describes how the finding below has been obtained with reference to FIGS. 4 to 7. FIG. 4 is a schematic view of blurs in an image through magnification radiography with X-ray fluoroscopy. FIG. 5 is a graph indicating convergence of a blur ratio relative to a magnification rate. FIG. 6 illustrates a section profile (simulation) while a focus size is changed at a magnification rate of 62.5 times and a pixel pitch of 50 μm, which are limit values of a condition expressed in Expression (2). FIG. 7 is a section profile (simulation) of a bump having a diameter of 20 μm in a condition of Expression (4).

As illustrated in FIG. 4, a size of an object O is denoted by r0, a size of a projection image of the object O on a (two-dimensional array type) detector is denoted by r1. Moreover, a focus size is denoted by φ, a size of a blur is denoted by a, and a magnification rate is denoted by c. Furthermore, a distance between a source S and the object O (SOD: Source Object Distance) is denoted by SOD, and a distance between the source S and the detector D (SID: Source Image Distance) is denoted by SID. Then, a magnification rate ε is expressed in an equation: ε=SID/SOD. Consequently, an equation expressing a relationship holds: r1=ε·r0. In addition, a similitude relationship causes holding of another equation: a:(SID−SOD)=φ:SOD. Therefore, a blur ratio a/r1 is expressed in Expression (1) as under:

a/r1=φ/r0·(1−1/ε)→φ/r0(ε→∞)→0(ε→1) (1)

As is clear from the above Expression (1), in a photographed image at a sufficiently high magnification rate (ε→∞), a blur ratio a/r1 converges to a ratio of focus size/object O (=φ/r0). On the other hand, a smaller blur is obtainable in contact radiography (i.e., radiography with the detector D being approached to the object O) such as when the magnification rate ε is close to 1 (ε→1). Consequently, an image with smaller blurs is obtainable even with a large focus size φ. Specifically, as illustrated in FIG. 5, the blur ratio almost converges at a magnification rate of around 10 times. In contrast to this, the blur ratio significantly decreases at the magnification rate of around 5 times in contact radiography.

For a first condition upon detecting a void with a diameter of 4 μm in a bump with a diameter of 20 μm, at least five pixels are required as a number of pixels by which the diameter of the bump contains in the 4 μm void. When the pixels are aligned in one direction, the center of the void is assumed as the center of the five pixels.

With three pixels, there are only pixels, other than the center pixel, that are adjacent to the center pixel. Accordingly, the pixel values of the adjacent pixels may vary due to noise, leading to a possibility that the adjacent pixels are not identified as voids. In some cases, this leads to another possibility that only the center pixel is used for void identification. In contrast to this, with five pixels, there are additional adjacent pixels (end pixels) other than the center pixels and pixels adjacent to the center pixel. The end pixels are adjacent to the adjacent pixels. Consequently, even when the pixel values of the end pixels vary due to noise to cause failure in identifying the end pixels as voids, the center pixel and also the adjacent pixels are usable for void identification. Taking the above reason into consideration, at least five pixels are required for void identification with a wafer bump inspecting apparatus.

From the above, for the first condition upon detecting a void with a 4 μm diameter in a bump with a 20 μm diameter, a condition expressed in Expression (2) below is given using a magnification rate ε and a pixel pitch d, wherein the pixel pitch is denoted by d [μm]:

4ε/d≧5 (2)

As illustrated in FIG. 6, a section profile (simulation) is generated while a focus size is changed at a magnification rate of 62.5 times and a pixel pitch of 50 μm (i.e., 4ε/50≧5→ε≧62.5), which are limit values of the condition expressed in the above Expression (2). Void detection (identification) is performed through binarization with a threshold value to determine a void region. Accordingly, in the section profile in FIG. 6, a void region is needed to have a peak (extreme) pixel value. As is apparent from FIG. 6, it is conceivable that void identification becomes difficult with a focus size beyond 2 μm.

From this, a condition for the focus size expressed in Expression (3) below is given:

φ≦2 [μm] (3)

Next, setting conditions are to be determined in contact radiography (radiography with the detector D being approached to the object O). In the above Expression (1), it is possible to interpret φ(1−1/ε) as an effective focus size including variations in blur due to different magnification rates. Accordingly, a condition of the focus size φ upon contact radiography is given as a function of the magnification rate ε. Extending the above Expression (3) to the effective focus size allows giving of Expression (4) below:

φ(1−1/ε)≦2 [μm]

∴φ≦2 [μm]·ε/(ε−1) (4)

As illustrated in FIG. 7, a section profile (simulation) of a bump having a 20 μm diameter is to be generated with the limit values in the Expression (4). Table 1 indicates correspondence of each condition.

TABLE 1

| magnification | SID | SOD | focus size | pixel pitch |
|---|---|---|---|---|
| rate | [cm] | [cm] | [μm] | [μm] |
| 3 | 60 | 20 | 3 | 2.4 |
| 2 | 60 | 30 | 4 | 1.6 |
| 1.5 | 60 | 40 | 6 | 1.2 |
| 1.005 | 60 | 59.70149 | 402 | 0.804 |

In the table, an SID (a distance between the source S and the detector D) has a fixed value of 60 cm, whereas an SOD (a distance between the source S and the object O) varies, whereby a magnification rate changes. Here, the magnification rate ε is expressed in an equation: ε=SID/SOD. Consequently, with the SID having the fixed value of 60 cm, a relationship holds between the magnification rate ε and the SOD: ε=60 [cm]/SOD [cm]. On the other hand, a relationship holds between the focus size and the magnification rate ε with the limit values in the above Expression (4): φ=2 [μm]·ε/(ε−1). Moreover, a relationship holds between the magnification rate ε and the pixel pitch d with the limit values in the above Expression (2): 4ε/d=5. In this manner, the magnification rate, the focus size, and the pixel pitch in the simulation of the contact radiography are generated while the SID is fixed to 60 cm and the SOD is changed. Table 1 indicates correspondence of these elements.

From FIG. 7, it is conceivable that all the section profiles almost conform to one another and a valley (extreme) value remains on both sides of the void in any condition in Table 1. Consequently, it is clear that the condition in the above Expression (4) is appropriate. Moreover, it is also conceivable that contact radiography with the object being approached to the detector within several millimeters allows detection (identification) of the void having a 4 μm diameter, even with radiography using a tube having a significantly large focus size (e.g., a focus size φ=402 μm with a magnification rate ε=1.005) as illustrated in Table 1.

The above Expressions (2) to (4) determine setting conditions for detecting a void having a 4 μm diameter. When a minimum radiography size is generalized by b [μm], it is conceivable that generalized setting conditions can be determined from the following Expressions (5) to (7).

Specifically, when the minimum radiography size is generalized from 4 μm to b [μm], it is conceivable that the above Expression (2) is generalized to the Expression (5) below for a first condition. On the other hand, upon detection of a void having a 4 μm diameter, it is conceivable, under the assumption that a focus size is 2 μm or less as half the 4 μm or less void, that 2 μm or less as half the minimum radiography size b [μm] or less is generalized by a focus size. As a result, it is conceivable that the above Expression (3) can be generalized to the Expression (6) below. Accordingly, relationships between the following Expressions (5) and (6) hold for the first condition.

bε/d≧5 (5)

φ≦b/2 (6)

In addition, as a setting condition (a second condition) in contact radiography, it is conceivable that the above Expression (2) is generalized to the following Expression (5). Moreover, when extension is made to the effective focus size, a term ε/(1−ε) is multiplied to the right side of the above Expression (6), resulting in generalization of the above Expression (4) to Expression (7) below. Consequently, it is conceivable that relationships of the Expressions (5) and (7) hold as the second condition.

bε/d≧5 (5)

φ≦b/2·ε/(1−ε) (7)

The above simulation causes generalization to the above Expressions (5) to (7). Accordingly, it has been found that, upon determination of setting conditions for the first condition so as to hold the relationships of the above Expressions (5) and (6), an object in minute size can be subjected to stable radiography or fluoroscopy while the object is magnified. In addition, it has also been found that, upon determination of setting conditions for the second condition so as to hold the relationships of the above Expressions (5) and (7), an object in minute size can be subjected to stable radiography or fluoroscopy while the object is magnified.

The present invention based on the above finding adopts the following configuration. That is, one embodiment (the former embodiment) of the present invention discloses a two-dimensional image detecting system. The two-dimensional image detecting system includes a generating source configured to generate light or radiation, and a two-dimensional array type detector with detecting elements being arranged in a two-dimensional array, the detecting elements being configured to detect the light or the radiation by converting the light or the radiation into charge information. The two-dimensional image detecting system detects a two-dimensional image based on the light or the radiation detected with the two-dimensional array type detector. A minimum radiography size is set in accordance with a focus size, and a magnification rate is set in accordance with the set minimum radiography size so as to hold relationships:

bε/d≧5

φ≦b/2,
wherein b denotes the minimum radiography size, ε denotes the magnification rate, d denotes a pixel pitch of the two-dimensional array type detector, and φ denotes the focus size of the generating source, the magnification rate being determined from distances among the generating source, an object, and the two-dimensional array type detector.

### [Operation and Effect]

With the two-dimensional image detecting system according to the embodiment (the former embodiment) of the present invention, when a conventional idea of determining setting conditions from a parameter of resolution (image resolution) is changed to use the generating source with a stable focus size, the setting conditions are determined from the focus size φ [μm] of the generating source. The minimum radiography size b [μm] is settable from the focus size φ [μm] and φ≦b/2 (the above Expression (6)). The magnification rate ε is settable from the set minimum radiography size b [μm], the pixel pitch d [μm] of the two-dimensional array type detector, and bε/d≧5 (the above Expression (5)). Consequently, the minimum radiography size b [μm] and the magnification rate ε are each settable with use of the generating source having the stable focus size φ [μm]. This results in stable radiography or fluoroscopy through magnifying the object in minute size.

Another embodiment (the latter embodiment), other than the former embodiment, of the present invention discloses a two-dimensional image detecting system including a generating source configured to generate light or radiation, and a two-dimensional array type detector with detecting elements being arranged in a two-dimensional array, the detecting elements being configured to detect the light or the radiation by converting the light or the radiation into charge information. The two-dimensional image detecting system detects a two-dimensional image based on the light or radiation detected with the two-dimensional array type detector. A minimum radiography size and a magnification rate are set in accordance with a focus size so as to hold relationships:

bε/d≧5

φ≦b/2·ε/(ε−1),
wherein b denotes the minimum radiography size, ε denotes the magnification rate, d denotes a pixel pitch of the two-dimensional array type detector, and φ denotes the focus size of the generating source, the magnification rate being determined from distances among the generating source, an object, and the two-dimensional array type detector.

### [Operation and Effect]

Similar to the former embodiment, with the two-dimensional image detecting system according to the embodiment (the latter embodiment) of the present invention, when a conventional idea of determining setting conditions from a parameter of resolution (image resolution) is changed to use the generating source with a stable focus size, the setting conditions are determined from the focus size φ [μm] of the generating source. In the latter, the magnification rate ε is set simultaneously with the minimum radiography size b [μm]. Specifically, when extension is made to the effective focus size including blur variations due to different magnification rates ε, the minimum radiography size b [μm] and the magnification rate ε are each settable from the focus size [μm], the magnification rate ε, and φ≦b/2·ε(ε−1) (the above Expression (7)) as well as the minimum radiography size b [μm], the pixel pitch d [μm] of the two-dimensional array type detector and bε/d≧5 (the above Expression (5)). Consequently, the minimum radiography size b [μm] and the magnification rate ε are each settable with use of the generating source having the stable focus size φ [μm]. This results in stable radiography or fluoroscopy through magnifying the object in minute size. In addition, the above Expressions (5) and (7) achieve the magnification rate ε extremely close to “1”. Accordingly, the setting condition in contact radiography can also be determined. In this manner, the clear setting condition in the contact radiography allows obtainment of required resolution even with a large focus size.

Examples of the above two-dimensional array type detector in the two-dimensional image detecting system (in the former and latter embodiments) include one having a direct conversion film configured to convert radiation into charge information directly. In a two-dimensional array type detector having an indirect conversion film to be mentioned later, a reaction position of radiation (emission position with radiation) is shifted from a position where a luminescent material captures radiation. In contrast to this, with the two-dimensional array type detector having the direct conversion film, electric charges formed by electrons and holes (positive holes) drift from the reaction position of radiation to collecting electrodes (pixel electrodes) configured to collect the charge information. Consequently, more excellent position resolution is obtainable than that by the two-dimensional array type detector with the indirect conversion film. As a result, the two-dimensional array type detector with the direct conversion film allows decrease in size of the blurs.

Examples of the above two-dimensional array type detector in the two-dimensional image detecting system (in the former and latter embodiments) include another one having an indirect conversion film configured to convert radiation into charge information indirectly by converting the radiation into the light temporarily and then converting the light into the charge information. The two-dimensional array type detector with the indirect conversion film achieves less noise than the two-dimensional array type detector with the direct conversion film. As a result, the two-dimensional array type detector with the indirect conversion film can obtain a high-resolution image with a low dose of radiation.

### Advantageous Effects of Invention

With the two-dimensional image detecting system (in the former embodiment), the minimum radiography size b [μm] and the magnification rate ε are each settable with use of the generating source having the stable focus size φ [μm]. This results in stable radiography or fluoroscopy through magnifying the object in minute size.

With the two-dimensional image detecting system according to the embodiment (in the latter embodiment) of the present invention, the minimum radiography size b [μm] and the magnification rate ε are each settable with use of the generating source having the stable focus size φ [μm]. This results in stable radiography or fluoroscopy through magnifying the object in minute size. The clear setting condition of the contact radiography allows obtainment of required resolution even with a large focus size.

It is to be understood that both the foregoing general description and the following detailed description are exemplary and explanatory and are intended to provide further explanation of the invention as claimed.

### BRIEF DESCRIPTION OF DRAWINGS

accompanying drawings, which are included to provide a further understanding of the invention and are incorporated in and constitute a part of this specification, illustrate embodiments of the invention, and together with the description serve to explain the principles of the invention.

FIG. 1 is a schematic view and a block diagram of a two-dimensional image detecting system according to one embodiment of the present invention.

FIG. 2 is a schematic sectional view of an X-ray detector according to the embodiment.

FIG. 3 is an equivalent circuit diagram of the X-ray detector according to the embodiment.

FIG. 4 is a schematic view illustrating an image blur upon magnification radiography through X-ray fluoroscopy.

FIG. 5 is a graph indicating a convergence of a blur ratio relative to a magnification rate.

FIG. 6 is a sectional profile (simulation) upon changing a focus size at a magnification rate of 62.5 times and a pixel pitch of 50 μm, which are limit values of a condition in Expression (2).

FIG. 7 is a sectional profile (simulation) of a bump having a diameter of 20 μm with limit values of a condition in Expression (4).

### DESCRIPTION OF EMBODIMENTS

The invention is described more full hereinafter with reference to the accompanying drawings, in which embodiments of the invention are shown. This invention may, however, be embodied in many different forms and should not be construed as limited to the embodiments set forth herein. Rather, these embodiments are provided on that this disclosure is thorough, and will fully convey the scope of the invention to those skilled in the art. In the drawings, the size and relative sizes of layers and regions may be exaggerated for clarity. Like reference numerals in the drawings denote like elements.

The following describes embodiments of the present invention with reference to drawings.

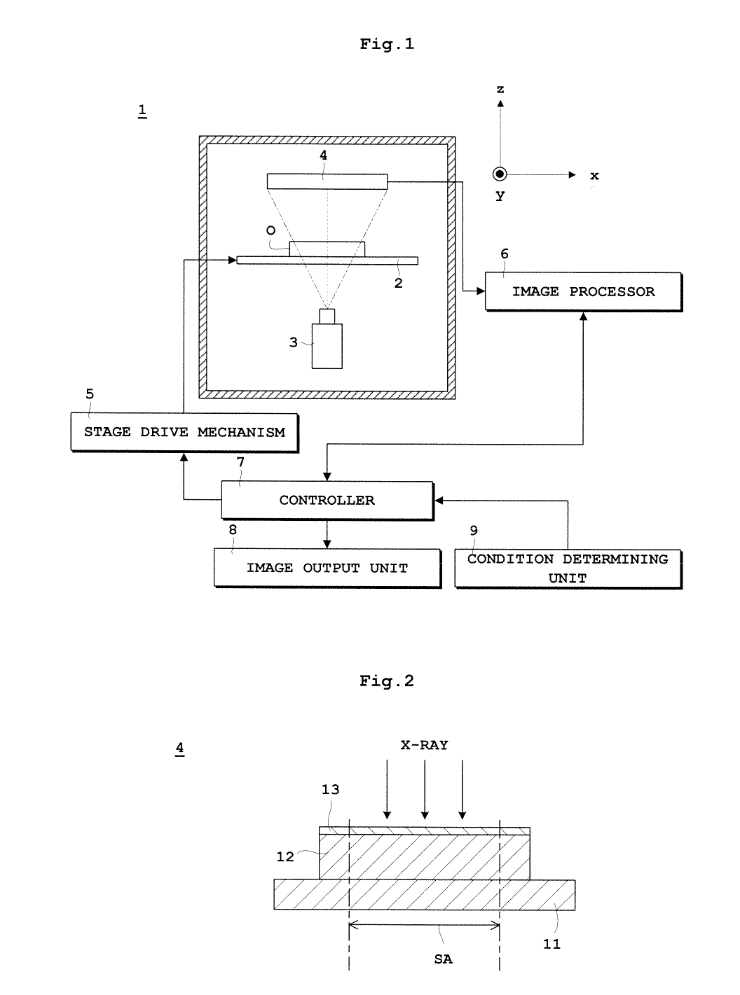

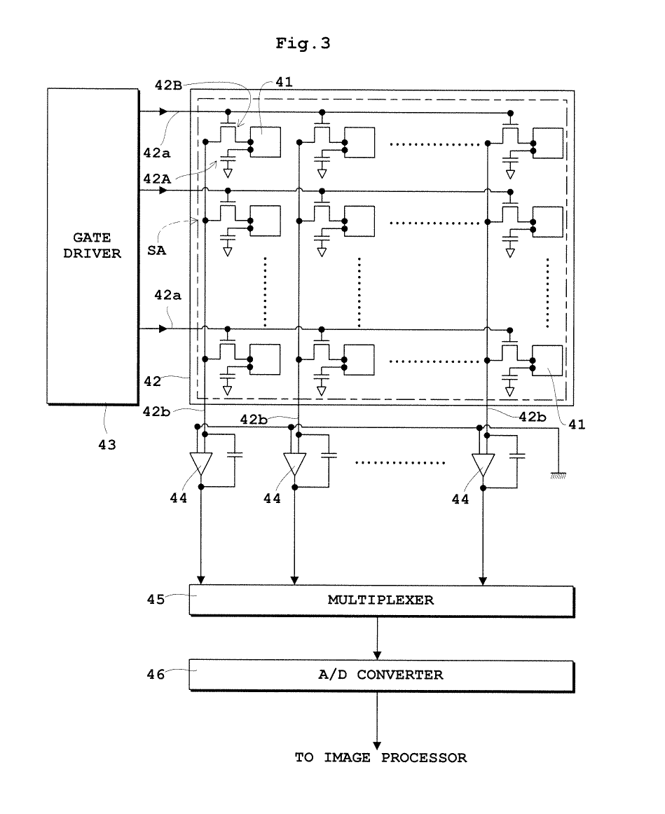

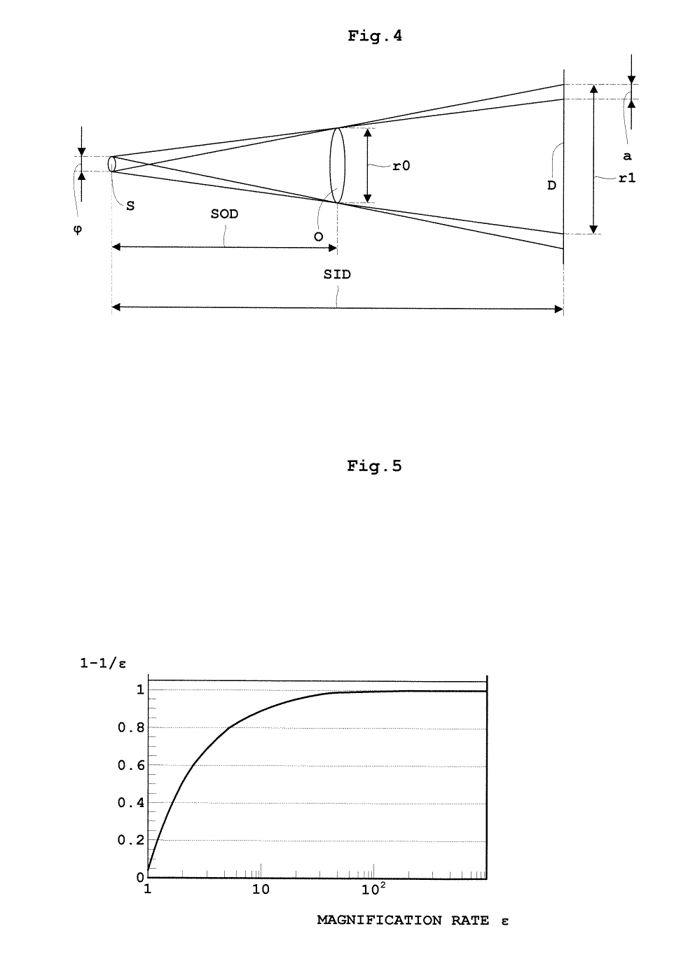

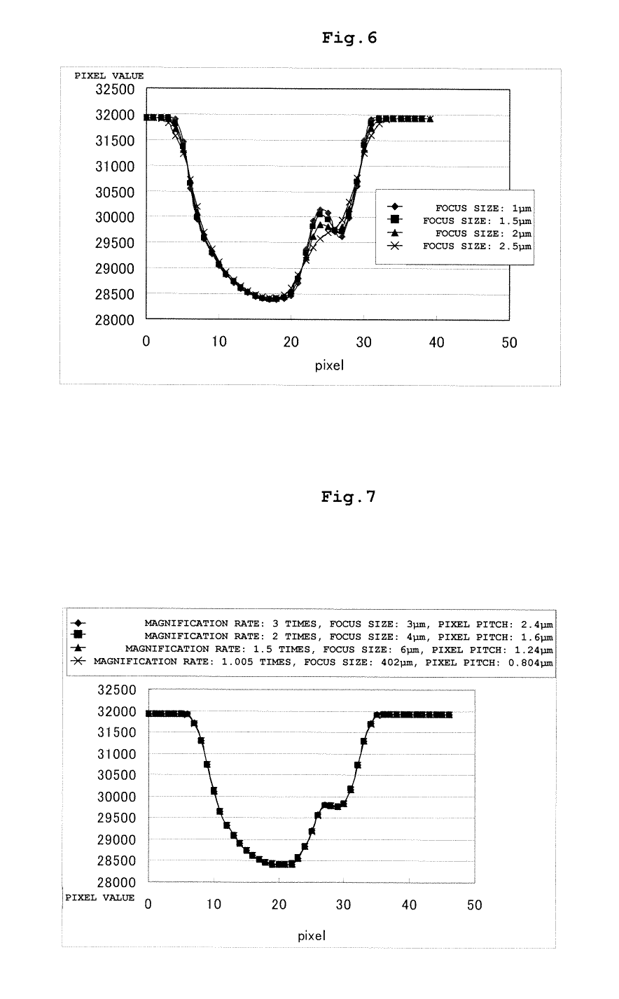

FIG. 1 illustrates a schematic view and a block diagram of a two-dimensional image detecting system according to one embodiment. FIG. 2 is a schematic sectional view of an X-ray detector according to the embodiment. FIG. 3 is an equivalent circuit diagram of the X-ray detector according to the embodiment. The embodiment has been described taking radiation as one example of X-rays, a microfocused X-ray tube as one example of a generating source, and a two-dimensional image detecting system as one example for use in a non-destructive inspecting apparatus.

As illustrated in FIG. 1, a two-dimensional image detecting system 1 includes a stage 2 configured to support an object O placed thereon, an X-ray tube 3 and an X-ray detector 4 facing to each other across the stage 2. In this embodiment, the X-ray tube 3 is constituted by the microfocused X-ray tube mentioned above, and emits X-rays in a cone-beam shape. A concrete configuration of the X-ray detector 4 is to be mentioned later. Here, the X-ray tube 3 corresponds to the generating source in the present invention. The X-ray detector 4 corresponds to the two-dimensional array type detector in the present invention.

The two-dimensional image detecting system 1 further includes a stage drive mechanism 5 as illustrated in FIG. 1. The stage drive mechanism 5 moves the stage 2 in three-axes (i.e., x-axis, y-axis, and z-axis) directions. The stage drive mechanism 5 drives a motor (not shown), thereby allowing the stage 2 to move on a horizontal plane (an x-y plane) and in a vertical axis (z-axis) direction. The vertical axis (z-axis) direction is orthogonal to the horizontal plane and connects the X-ray tube 3 and the X-ray detector 4. Such movement achieves changing an observing position or a magnification rate.

The two-dimensional image detecting system 1 further includes an image processor 6, a controller 7, an image output unit 8, and a condition determining unit 9. The image processor 6 performs image processing in accordance with a plurality of two-dimensional images detected with the X-ray detector 4. The controller 7 controls en bloc the image processing. The image output unit 8 outputs the images (displays the images on a monitor or outputs printing of the images to a printer). The images are subjected to the image processing with the image processor 6. The condition determining unit 9 determines a setting condition.

The image processor 6 adds the plurality of two-dimensional images to perform frame average, thereby obtaining a two-dimensional image with reduced noise. The two-dimensional image obtained in this manner is outputted for radiography. Of course, fluoroscopy may be conducted by displaying the plurality of two-dimensional images on a monitor (not shown) of the image output unit 8 successively in real time. Alternatively, X-ray CT may be conducted in which the plurality of two-dimensional images is reconstructed to generate a three-dimensional image.

In the case of X-ray CT, the X-ray detector 4 detects X-rays emitted from the X-ray tube 3 through the object O on the stage 2 while the stage 2 rotates around the vertical axis. When contact radiography is conducted with X-ray CT, X-rays are emitted in an oblique direction at a lamino angle from the vertical axis (z-axis). This allows the X-ray tube 3 to approach to the object O without any constraints in size of the stage 2. Alternatively, in the case of X-ray CT, X-rays may be emitted while the X-ray tube 3 and the X-ray detector 4 rotate around the stage 2. Moreover, X-rays may be emitted while the X-ray detector 4 moves on a circular orbit concentrically in synchronization with movement of the stage 2 on the circular orbit. Here, an orientation of the stage 2 is fixed constantly.

The image processor 6, the controller 7, and the condition determining unit 9 are each constituted by a central processing unit (CPU) or the like. A function of the condition determining unit 9 is to be mentioned later in detail.

As illustrated in FIG. 2, the X-ray detector 4 includes an active matrix substrate 11, an X-ray sensitive semiconductor device 12, and a common electrode 13 for bias voltage application. The semiconductor device 12 is formed by a direct conversion film that converts X-rays into charge information directly. As illustrated in FIG. 3, the active matrix substrate 11 forms a plurality of collecting electrodes 41 (also referred to as “pixel electrode”) on an X-ray incident face thereof. The active matrix substrate 11 has an electric circuit 42 for accumulating and reading electric charges collected in each of the collecting electrodes 41. The collecting electrodes 41 are arranged in a two-dimensional matrix array within an effective area SA for detecting X-rays. The X-ray sensitive semiconductor device 12 corresponds to the direct conversion film in the present invention.

As illustrated in FIG. 3, the active matrix substrate 11 forms the collecting electrodes (pixel electrodes) 41 mentioned above, and arranges the accumulation and read electric circuit 42. The accumulation and read electric circuit 42 is constituted by capacitors 42A, TFTs (thin film field-effect transistor) 42B as switching elements, gate lines 42a, and data lines 42b. One capacitor 42A and one TFT 42B are correspondingly connected to every collecting electrode 41. The collecting electrode (pixel electrode) 41, the capacitor 42A, and the TFT 42B correspond to the detecting element in the present invention.

A gate driver 43, a charge-voltage conversion amplifier 44, a multiplexer 45, and an A/D converter 46 are arranged around the accumulation and read electric circuit 42 of the active matrix substrate 11. The gate driver 43, the charge-voltage conversion amplifier 44, the multiplexer 45, and the A/D converter 46 are connected to a substrate other than the active matrix substrate 11. Here, the gate driver 43, the charge-voltage conversion amplifier 44, the multiplexer 45, and the A/D converter 46 may be partially or entirely embedded in the active matrix substrate 11 (see FIG. 2).

The X-ray detector 4 is also referred to as a “flat panel X-ray detector (FPD)”. The X-ray detector 4 has the detecting elements (the collecting electrodes (pixel electrodes) 41, the capacitors 42A, and the TFTs 42B) arranged in a two-dimensional array. The detecting elements detect X-rays by converting X-rays into charge information.

Upon detection of X-rays with the X-ray detector 4, a bias supply power source (not shown) supplies bias voltages via a lead (not shown) for bias voltage supply to a common electrode 13 for bias voltage supply. The X-ray sensitive semiconductor device 12 generates electric charges upon incidence of X-rays with the bias voltages being applied. The generated electric charges are temporarily collected in the collecting electrodes 41. The accumulation and read electric circuit 42 extracts the collected electric charges as X-ray detection signals for every collecting electrode 41.

Specifically, the electric charges collected in the collecting electrode 41 are temporarily accumulated in the capacitor 42A. Thereafter, read-out signals are applied from the gate driver 43 via the gate line 42a to each gate of the TFTs 42B in turn. Applying the read-out signals turns the TFT 42B, receiving the read-out signals, ON from OFF. The multiplexer 45 switches the data line 42b connected to a source of the turned TFT 42B, and accordingly reads out the electric charges accumulated in the capacitor 42A from the TFT 42B via the data line 42b. The charge-voltage conversion amplifier 44 amplifies the read-out electric charges. The multiplexer 45 sends the electric charges to the A/D converter 46 as the X-ray detection signals for every collecting electrode 41, thereby converting analog values to digital values.

Moreover, the digital values in the A/D converter 46 are sent to the image processor 6 (see FIG. 1), whereby a two-dimensional image is outputted. The collecting electrodes 41 in the two-dimensional matrix array each correspond to electrodes for every pixel of the two-dimensional image. Extracting the X-ray detection signals achieves generation of a two-dimensional image depending on a two-dimensional intensity distribution of X-rays projected on the X-ray detection effective area SA. In other words, the X-ray detector 4 is a two-dimensional array type detector that allows detection of the two-dimensional intensity distribution of X-rays projected on the X-ray detection effective area SA.

As noted above, the X-ray detector 4 in the embodiment includes the X-ray sensitive semiconductor device 12 constituted by the direct conversion film. The direct conversion film converts X-rays into charge information directly. With the two-dimensional array type detector having the indirect conversion film, the reaction position (emission position with radiation) of radiation (X-rays in the embodiment) shifts from the position where the luminescent substrate captures light. In contrast to this, with the two-dimensional array type detector (the X-ray detector 4) having the direct conversion film, electric charges formed by electrons and holes (positive holes) drift from the reaction position of radiation (X-rays) to collecting electrodes (pixel electrodes) 41 configured to collect the charge information. Consequently, more excellent position resolution is obtainable than that by the two-dimensional array type detector with the indirect conversion film. As a result, the two-dimensional array type detector (the X-ray detector 4) with the direct conversion film allows decrease in size of the blurs.

The X-ray sensitive semiconductor device 12 is formed of CdTe, ZnTe, CdZnTe, HgI₂, PbI₂, PbO, BiI₃, TlBr, Se, Si, GaAs, or InP, or a mixed crystal thereof. The semiconductor device made of CdTe, ZnTe, CdZnTe, HgI₂, PbI₂, PbO, BiI₃, TlBr, or GaAs achieves a detector with high sensitivity and high noise resistance. The semiconductor device made of Se facilitates obtaining of a uniform and large detector. The semiconductor device made of Si, or InP achieves a detector with high energy resolution.

The following describes a concrete function of the condition determining unit 9. Upon delivering or installing the two-dimensional image detecting system 1, the condition determining unit 9 is set so as to determine setting conditions from a focus size φ [μm] of the X-ray tube 3 provided with the two-dimensional image detecting system 1. For a first condition, the Expressions (5) and (6) determine setting conditions of a minimum radiography size b [μm] and a magnification rate c. The setting conditions are sent to the controller 7 every time radiography or fluoroscopy is conducted so as to correspond to the setting conditions of the minimum radiography size b [m] and the magnification rate ε determined from the condition determining unit 9. Then the controller 7 controls the stage drive mechanism 5 so as to adapt the setting conditions for moving the stage 2. The stage 2 is moved to a position corresponding to the determined magnification rate ε, where radiography or fluoroscopy is conducted.

Other than the first condition mentioned above 1, the Expressions (5) and (7) determine setting conditions of a minimum radiography size b [μm] and a magnification rate ε for a second condition upon conducting contact radiography. The setting conditions are sent to the controller 7 every time radiography or fluoroscopy is conducted so as to correspond to the setting conditions of the minimum radiography size b [μm] and the magnification rate ε determined from the condition determining unit 9. Then the controller 7 controls the stage drive mechanism 5 so as to adapt the conditions for moving the stage 2. The stage 2 is moved to a position corresponding to the determined magnification rate ε, where radiography or fluoroscopy is conducted.

Here, the setting conditions are invariant when the condition determining unit 9 is set to determine the setting conditions from the focus size φ [μm] of the X-ray tube 3 upon delivering or installing the two-dimensional image detecting system 1. However, this is not limitative. For instance, even with use of the X-ray tube 3 having a fixed focus size φ [μm], the setting conditions of the minimum radiography size b [μm] and the magnification rate ε may be determined repeatedly for every use of the X-ray tube 3 from the Expressions (5) and (6) or from the Expressions (5) and (7).

With the two-dimensional image detecting system 1 mentioned above, when a conventional idea of determining the setting conditions from a parameter of resolution (image resolution) is changed to use the generating source (X-ray tube 3) with a stable focus size φ [μm], the setting conditions are determined from the focus size φ [μm] of the generating source (the X-ray tube 3). The minimum radiography size b [μm] is settable from the focus size φ [μm] and φ≦b/2 (the above Expression (6)). The magnification rate ε is settable from the set minimum radiography size b [μm], the pixel pitch d [μm] of the two-dimensional array type detector (the X-ray detector 4 in the embodiment) and bε/d≧5 (the above Expression (5)). Consequently, the minimum radiography size b [μm] and the magnification rate ε are each settable with use of the generating source (X-ray tube 3) having the stable focus size φ [μm]. This results in stable radiography or fluoroscopy through magnifying the object O in minute size.

Moreover, the magnification rate ε is set simultaneously with the minimum radiography size b [μm]. Specifically, when extension is made to the effective focus size including blur variation due to different magnification rates ε, the minimum radiography size b [μm] and the magnification rate ε are each settable from the focus size φ [μm], the magnification rate ε and φ≦b/2·ε/(ε−1) (the above Expression (7)) as well as the minimum radiography size b[μm] and the pixel pitch d[μm] of the two-dimensional array type detector (the X-ray detector 4) and bε/d≧5 (the above Expression (5)). Consequently, the minimum radiography size b [μm] and the magnification rate ε are each settable with use of the generating source (X-ray tube 3) having the stable focus size φ [μm]. This results in stable radiography or fluoroscopy through magnifying the object in minute size. In addition, the above Expressions (5) and (7) achieve the magnification rate ε extremely close to “1”. Accordingly, the setting conditions in contact radiography can also be determined. In this manner, the clear setting conditions of the contact radiography allow obtainment of required resolution even with a large focus size.

The present invention is not limited to the above embodiments, but may be modified as follows.

(1) The embodiments mentioned above adopt X-rays as radiation, and have described the X-ray detector configured to detect X-rays as one example. Alternatively, the present invention is applicable to a radiation detector configured to detect radiation other than X-rays (i.e., α-rays, β-rays, γ-rays) or to a light detector configured to detect light.

(2) In the embodiments mentioned above, the two-dimensional array type detector (the X-ray detector in the embodiments) has the direct conversion film that converts radiation (X-rays in the embodiments) into charge information directly. Alternatively, a two-dimensional array type detector having an indirect conversion film is applicable. The indirect conversion film converts radiation into charge information indirectly by temporarily converting radiation into light and then converting the light into charge information. For instance, the two-dimensional array type detector is used having an indirect conversion film in combination of an image intensifier (I.I) or a luminescent substrate (e.g., of CsI or NaI) and a light-sensitive semiconductor device or a photodiode. The two-dimensional array type detector having the indirect conversion film achieves less noise than the two-dimensional array type detector having the direct conversion film mentioned above. Consequently, the two-dimensional array type detector having the indirect conversion film allows obtainment of a high-resolution image with a low dose of radiation.

(3) The embodiments describe the two-dimensional array type detector having a construction that the semiconductor device (the X-ray sensitive semiconductor device in the embodiments) is formed on the substrate (active matrix substrate in the embodiments), and the common electrode 13 is formed on the semiconductor device. Alternatively, a two-dimensional array type detector may be adopted having opposite substrates whose pixels are electrically connected. One of the substrates has the semiconductor device being formed on common electrodes, the common electrodes are formed on a support substrate transparent to radiation or light (e.g., a glass or ceramic (Al₂O₃,AlN), or a silicone). The other substrate has read-out patterns, such as the detecting element, being formed thereon. In addition, when the support substrate is formed by a conductive material such as a graphite substrate, the common electrodes may be omitted.

(4) The embodiment mentioned above adopts the microfocused X-ray tube configured to output X-rays in a minute focus size (e.g., several μm or less). However, this is not limited to the X-ray tube configured to output X-rays in a minute focus size. As illustrated in the Table 1 above, the present invention is applicable to the X-ray tube configured to output X-rays in an extremely large focus size (φ=402 μm).

### INDUSTRIAL APPLICABILITY

As noted above, the present invention is suitable to a two-dimensional image detecting system having a microfocused X-ray tube for use in a non-destructive inspecting apparatus.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### REFERENCE SIGNS LIST

3 . . . X-ray tube
4 . . . X-ray detector
12 . . . (X-ray sensitive) semiconductor device
41 . . . collecting electrode (pixel electrode)
42A . . . capacitor
42B . . . TFT (thin film field-effect transistor)
b . . . minimum radiography size
ε . . . magnification rate
d . . . pixel pitch
φ . . . focus size
O . . . object

What is claimed is:

1. A two-dimensional image detecting system configured to detect a two-dimensional image based on light or radiation detected, the system comprising:
a generating source configured to generate the light or the radiation; and
a two-dimensional array type detector with detecting elements being arranged in a two-dimensional array, the detecting elements being configured to detect the light or the radiation by converting the light or the radiation into charge information, wherein
a minimum radiography size is set in accordance with a focus size, and a magnification rate is set in accordance with the set minimum radiography size so as to hold relationships:
bε/d≧5
φ≦b/2,
wherein b denotes the minimum radiography size, c denotes the magnification rate, d denotes a pixel pitch of the two-dimensional array type detector, and φ denotes the focus size of the generating source,
the magnification rate being determined from distances among the generating source, an object, and the two-dimensional array type detector.

2. A two-dimensional image detecting system configured to detect a two-dimensional image based on the light or radiation detected, the system comprising:
a generating source configured to generate light or radiation; and
a two-dimensional array type detector with detecting elements being arranged in a two-dimensional array, the detecting elements being configured to detect the light or the radiation by converting the light or the radiation into charge information, wherein
a minimum radiography size and a magnification rate are set in accordance with a focus size so as to hold relationships:
bε/d≧5
φ≦b/2·ε/(ε·1),
wherein b denotes the minimum radiography size, ε denotes the magnification rate, d denotes a pixel pitch of the two-dimensional array type detector, and φ denotes the focus size of the generating source,
the magnification rate being determined from distances among the generating source, an object, and the two-dimensional array type detector.

3. The two-dimensional image detecting system according to claim 1, wherein
the two-dimensional array type detector includes a direct conversion film configured to convert the radiation into the charge information directly.

4. The two-dimensional image detecting system according to claim 1, wherein
the two-dimensional array type detector includes an indirect conversion film configured to convert the radiation into the charge information indirectly by converting the radiation into the light temporarily and then converting the light into the charge information.

5. The two-dimensional image detecting system according to claim 2, wherein
the two-dimensional array type detector includes a direct conversion film configured to convert the radiation into the charge information directly.

6. The two-dimensional image detecting system according to claim 2, wherein
the two-dimensional array type detector includes an indirect conversion film configured to convert the radiation into the charge information indirectly by converting the radiation into the light temporarily and then converting the light into the charge information.
